(19) United States
(12) Patent Application Publication
(10) Pub. No.: US 2003/0233152 A1
(43) Pub. Date: Dec. 18, 2003

(54) Data processing apparatus and method for manufacturing the same

(76) Inventor: Motoharu Oda, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/173,016

(22) Filed: Jun. 18, 2002

(51) Int. Cl. G05B 15/00

(52) U.S. Cl. 700/1

(57) ABSTRACT

A data processing apparatus, which can prevent a reduction of the number of persons accommodated in shop, and can be used as a terminal for realizing an environment capable of using a communication network such as Internet and the like. A data processing apparatus 100 has an external appearance such that a plate-shaped main body 101 is supported by two legs 101. An upper surface of the main body 101 is provided with a flat plate 103 covering the entire surface of the main body 101, and a lower side of the flat plate 103 is provided with a display device 104 having display screens 104a and 104b facing the flat plate 103. Further, the main body 101 is mounted with various devices such as an input device 105 and a pointing device 106 so that the data processing apparatus 100 can be used as a terminal for making a connection with a communication network.

### BACKGROUND OF THE INVENTION

1. Field of the Invention

The present invention relates to a data processing apparatus, which is used as a terminal for establishing a connection with a communication network.

2. Description of the Related Art

In recent years, a typical communication network such as the Internet has socially come into wide use, and network users are rapidly increasing. Under such circumstances, various services using the communication network have been provided.

For example, in many restaurants, it takes time inn some degree that ordered food and drinks are served to users. For this reason, some restaurants prepare a terminal device connectable with the Internet for each table in order to realize an environment such that the users can enjoy themselves during the waiting time as described above. Moreover, a coffee shop capable of receiving Internet service, a so-called Internet cafe appears, and the number of the Internet cafes is increasing.

The above shops such as Internet cafe and restaurants have employed a data processing apparatus such as a personal computer as a terminal, or a data processing apparatus developed as a dedicated terminal. However, the conventional data processing apparatus as described above must be installed on a table. For this reason, in the case where the conventional data processing apparatus is employed as the terminal, there is a problem of taking up space on the table which is otherwise used by the customer.

In this case, many shops have no extra space for customers' use in view of space economy. Unless there is an extra space in some degree, it is undesirable to take up space for any reason on the table otherwise usable for the customers. Therefore, for realizing an environment capable of using the Internet in many shops, larger tables must be prepared so as to make up for the taken-up space such that the space is sufficient for the customers use.

If the shop prepares such larger table, the number of shop employees cannot but to be reduced. Depending upon the situation, the need for remodeling the shop arises. Moreover, such reduction of the number of shop employees can affects shop's earnings. Thus, in the case of realizing an environment which allows use of the Internet, the above problem causes an economical demerit. As a result, it is important to solve the problem such that the reduction of the number of shop employees must be avoided.

### SUMMARY OF THE INVENTION

The present invention has been made in view of the above problems. Accordingly, an object of the present invention is to provide a data processing apparatus, which can prevent a reduction of the number of persons accommodated in shop, and can be used as a terminal for realizing an environment capable of using a communication network such as Internet.

The data processing apparatus according to one aspect of the present invention is manufactured on the premise that it is used as a terminal for making a connection with a communication network, and includes the following means.

In order to achieve the above object, according to the first aspect, the present invention provides a data processing apparatus, which is used as a terminal for making a connection with a communication network, comprising:

a display device manufactured and used on the premise that something is put thereon, and having a display screen facing a flat-plate transmitting portion capable of transmitting a light;

communication means for making a communication with the communication network;

input means for inputting a request by a user; and

control means for carrying out a control in a manner that a data corresponding to the request inputted by the input means is received by the communication means receives, and the received data is displayed on the display screen by the display device.

In the data processing apparatus, the display device further includes selection means for selecting a direction of displaying a data on the display screen by the user, and the control means carries out in a manner that the display device displays the data on the display screen according to the direction selected by the selection means, that is, the user.

In the data processing apparatus, preferably, in the case where a plurality of the input means is provided, the control means selects a valid input means from the plurality of the input means according to the direction selected by the selection means, that is, the user.

Further, according to another aspect, the present invention provides a method for manufacturing a data processing apparatus, which is used as a terminal for making a connection with a communication network, comprising the following steps of:

providing a transmitting portion capable of transmitting a light at a surface used for putting something on a table;

providing a display device having a display screen facing the transmitting portion provided at the surface; and

mounting communication means for making a communication with the communication network, input means for inputting a request by a user, and control means for carrying out a control in a manner that a data corresponding to the request inputted by the input means is received by the communication means receives, and the received data is displayed on the display screen by the display device, which constitute the data processing apparatus, to the table.

According to the present invention, the data processing apparatus is used as a terminal for making a connection with a communication network, and is mounted to a table. Further, the data (image) is displayed on the display device provided at the surface of the table used for putting something.

In the case where the data processing apparatus has the above construction, the data processing apparatus is usable as a table, in addition to the terminal. Therefore, the data processing apparatus is installed, and thereby, it is possible to prevent a reduction of a space usable by the customer. As a result, it is possible to prevent a reduction of the number of persons accommodated in shop, and to realize an environment capable of using a communication network such as Internet and the like.

### BRIEF DESCRIPTION OF THE DRAWINGS

The above and further objects and features of the present invention will become more fully apparent from the following detailed description with reference to the accompanying drawings in which:

FIG. 1 is a perspective view showing an external appearance of a data processing apparatus according to one embodiment of the present invention;

FIG. 2 is a block diagram showing a circuit configuration of the data processing apparatus of the present invention according to the embodiment of the present invention; and

FIG. 3 is a view showing a configuration of a network system built up using the data processing apparatus according to the embodiment of the present invention.

### DETAILED DESCRIPTION OF THE PREFERRED EMBODIMENTS

The preferred embodiments of the present invention will be described in detail with reference to the accompanying drawings.

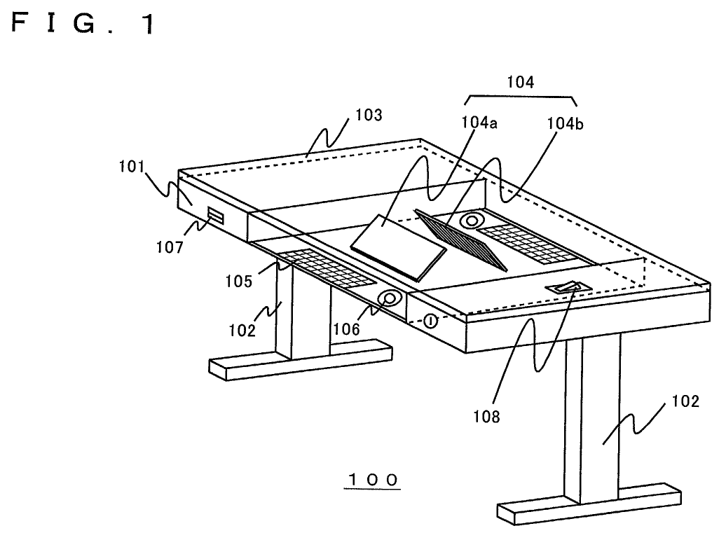

FIG. 1 is a perspective view showing an external appearance of a data processing apparatus according to one embodiment of the present invention.

A data processing apparatus 100 is manufactured on the assumption that it is used as a terminal of communication network as well as a table. More specifically, the data processing apparatus 100 is manufactured on the assumption that it is installed in a shop such as a coffee shop and the like. As the shown in FIG. 1, the data processing apparatus 100 is composed of a thick plate-shaped main body 101 formed with an intermediate recessed portion in the form of a relatively wide rectangular floor while opposite lateral side portions thereof are left in the form of raised platforms. Said main body 101 is supported on two legs 102.

The upper portion of the main body 101 is provided with a flat plate 103 covering the entire surface thereof. The flat plate 103 is formed of a thick glass plate transmitting a light and prepared on the assumption that something is to be placed thereon. Thus, said main body 101 and said thick glass plate 103 placed thereon defines a rectangular space which can be reached by customers who are supposed to take seats in front of the data processing apparatus or the table 100. Said space under the flat space 103 is equipped with a display device 104 including display screens 104a and 104b below the flat plate 103. As described above, the display screens 104a and 104b are arranged below the flat plate 103 without the problem of taking up table space unnecessarily In this case, the flat plate 103 may be partially provided so as to cover only display screens 104a and 140b if the raised portions on opposite lateral sides are designed to extend into portions left uncovered by the flat plate 102. Further, the flat plate 103 may be freely replaced with another thing.

Further, as shown in FIG. 1, there are provided input devices in front of the respective display screen 104a and 104b provided in the space defined by the main body 101 and the flat plate, said input devices including for example, keyboards 105 for various data input and pointing devices (joystick in this case) 106. There are further formed card slots 107in the front sides of the raised portions of the main body 101. It is to be noted that the input devices are provided reachable from the front sides of the main body 101. Therefore, the data processing apparatus 100 is operable on both of two sides. By doing so, a user can select a position to be sat for operating the data processing apparatus 100, and thereby, it is possible to improve the use of easiness for the user. Hereinafter, for convenience of explanation, the side showing the input device 105 in FIG. 1 is referred to as a first side; on the other hand, a side facing the first side is referred to as a second side.

The display device 104 has two display screens 104a and 104b as described above. This considers the following points. That is, in the case where the user sits on the first side and operates the data processing apparatus, an image is displayed on the display screen 104a arranged on the first side in a direction where the user is easy to see. On the other hand, in the case where the user sits on the second side and operates the data processing apparatus, the image is displayed on the display screen 104b arranged on the second side in a direction reverse to the above direction where the user is easy to see. In order to readily see the display screen by the user, the display screens 104a and 104b are arranged at an angle, and not arranged parallel with the flat plate 103. A changeover switch 108 provided at one side end on the upper surface of the main body 101 is used in the case where the user selects a display screen to be displayed from the display screens 104a and 104b.

In addition, two display screens 104a and 104b are not arranged, and only one may be arranged so that only direction displaying the image can be changed. Further, the above two display screens 104a and 104b display the image independently from each other, and thereby, two users may simultaneously use the data processing apparatus 100.

Moreover, the data processing apparatus 100 having the external appearance as shown in FIG. 1 is usable as a table; therefore, it is possible to solve the problem of taking up the space on the apparatus or the table 100 which is otherwise is usable by the customer. As a result, in the already existing shop, the old table is merely replaced with the data processing apparatus 100 without changing the table arrangement, interior and the like. By doing so, it is possible to realize an environment allowing the use of communication networks without the problem of having to reduce the number of shop employees. Further, a start-up cost for realizing the environment is saved; therefore, the shop can further readily realize the above environment. The data processing apparatus 100 has a larger size than the conventional apparatus; therefore, antitheft effect can be obtained.

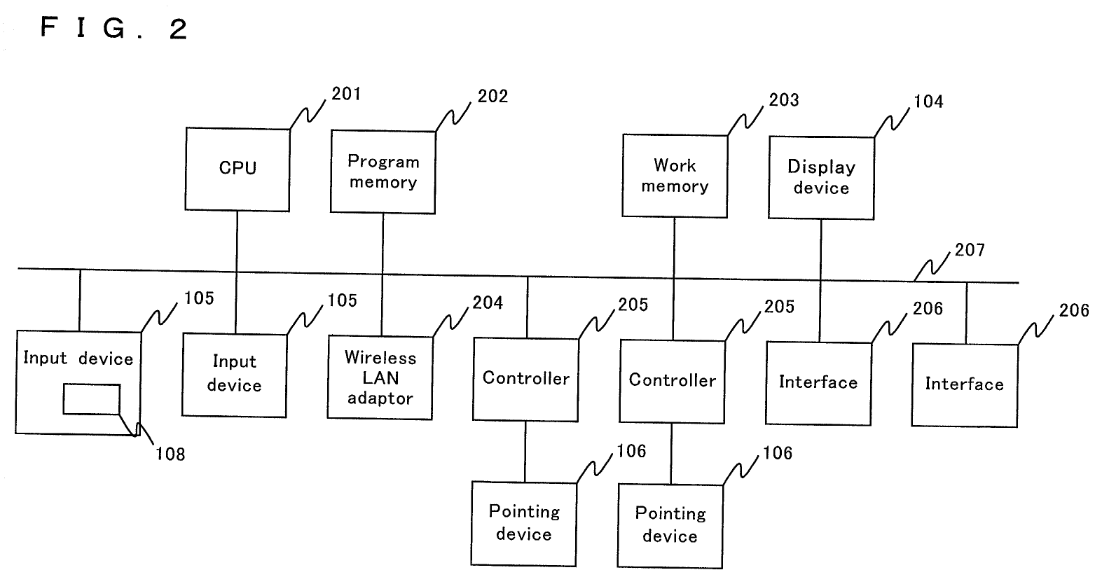

FIG. 2 is a block diagram showing a circuit configuration of the above data processing apparatus 100.

As shown in FIG. 2, the data processing apparatus 100 comprises a CPU 201 for controlling the entirety of the apparatus 100, a program memory 202, a work memory 203 used for work by the CPU 201, the above display device 104, two input devices 105, a wireless LAN apparatus 204 provided as a communication means, two pointing devices 106 (joystick) provided in the respective first and second sides, two controllers 205 provided for controlling said devices 106, two interfaces 206 for two card slots 107 provided in the respective first and second sides, and a bus 207 for interconnecting the CPU 201 to the respective portions 202 through 206 and the input devices 105. More specifically, the program memory 202 stores programs (including browser) executed by the CPU 201, and the above two input devices 105 individually have a control panel provided on the first and second sides. Further, the above two pointing devices 106 are individually provided on the first and second sides, and two controllers 205 are prepared for controlling two pointing devices 106. Further, the above two interfaces 206 for two card slots 107 are individually provided on the first and second sides, and the bus 207 interconnects the CPU 201 with the above sections 202 to 206 and 105.

The above program memory 202 is a PROM such as flash memory, for example. The reason why the above PROM is employed as the program memory 202 is as follows; more specifically, the PROM has a lower failure rate and is durable to vibration as compared with a hard disk drive, and besides, is suitable for preventing a selfish setup by the customer.

In the present embodiment, the data processing apparatus 100 is mounted with a wireless LAN adaptor 204 for making a communication with communication network. In this case, the data processing apparatus 100 may be mounted with other communication hardware such as modem (telephone line, xDSL (for example, ADSL) line, or CATV line). Further, a plurality of communication hardware may be mounted in order to make a communication with plural kinds of communication networks.

The main body 101 is manufactured in a state that the circuit configuration shown in FIG. 2 is all mounted. By doing so, the data processing apparatus 100 is realized as a terminal connectable with the above communication network.

Based on the above configuration, an operation of the data processing apparatus 100 will be described below.

When a power supply (not shown) is turned on, the CPU 201 reads out the program stored in the program memory 202, then, executes the program, and thereby, starts the control for the entirety of the data processing apparatus 100. The above control is carried out according to the user's operation to the input device 105 or the pointing device 106, or data received by the wireless LAN adaptor 204.

The input device 105 is mainly used for inputting a keyword in URL and search or for authoring a mail and the pointing device 106 is used for clicking various icons and buttons (including link button or the like). The CPU 201 analyzes the data outputted from the above devices so as to specify a request from the user, and then, carries out the control corresponding to the request. The CPU 201 carries out the control so that an image (data) to be displayed can be displayed on the display screen 104a or 104b of the display device 104, and thereafter, acquires a data to be acquired via the wireless LAN adaptor 204.

Sequentially, the CPU 201 stores the data acquired via the wireless LAN adaptor 204 in the work memory 203, and then, makes an analysis. Based on the analysis result, the CPU 201 generates an image to be displayed, and transmits the image data to the display device 104, and thereby, the image is displayed on the display screen 104a or 104b.

The above changeover switch 108 is used as an operating element included in one input device 105. In the case where a state of the switch 108 changes, the input device 105 transmits a data indicative of the state after changed to the CPU 201.

When receiving the data from the input device 105, the CPU 201 makes a changeover of the display screen displaying the image with respect to the display device 104. In accordance with the changeover, only one of two input devices 105 and two controllers 205 is used as being valid. More specifically, only input device 105 and pointing device 106 arranged on the display screen side, used for the display are made valid. In the manner as described above, even if the user sits on either of the first or second side, the user can comfortably use the data processing apparatus 100. Of course, the operation to the changeover switch 108 is always valid.

The above card slot 107 is connectable with a flexible disk, a magneto-optical disk, or a recording apparatus capable of using a recording medium such as a CD-RW. In the case of lending the recording apparatus according to the user's request, the data downloaded via the communication network is saved in the recording medium, and thereafter, the user may bring back the recording medium.

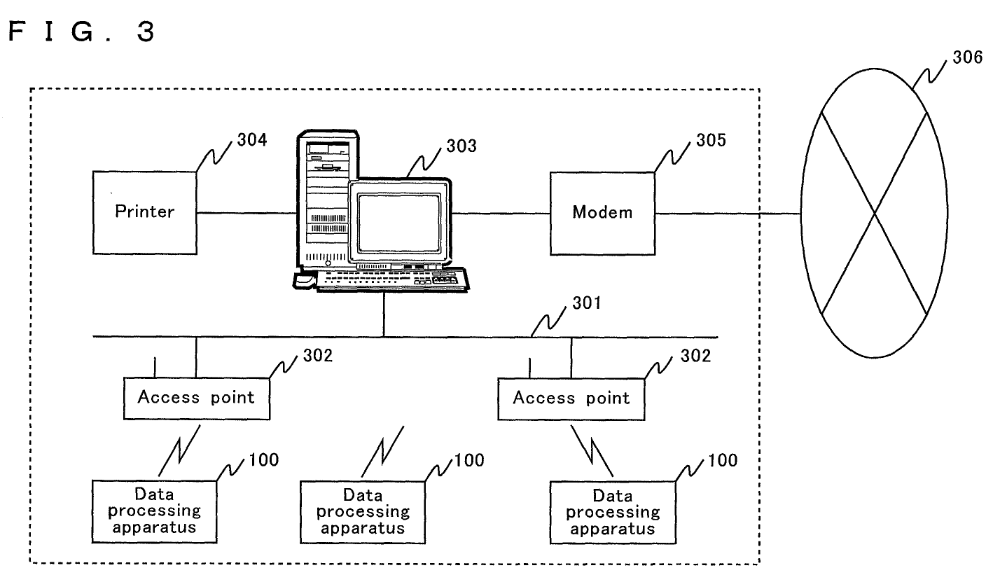

FIG. 3 is a view showing a configuration of a network system built up using the data processing apparatus 100 of the present invention.

The network system is built up so that the user of the data processing apparatus 100 can use Internet 306. As shown in FIG. 3, a wired LAN 301 is connected with a plurality of access points 302, which is a bridge for making a communication with the data processing apparatus 100, and one personal computer (hereinafter, referred to as PC) 303, which functions as a server.

The PC 303 is connected with a printer 304 and a modem 305. The modem 305 is a modem for ADSL line, for example. Thus, the data processing apparatus 100 is connected with Internet 306 via the access point 302, the wired LAN 301, the PC 303, the modem 305 and ISP (Internet Service Provider) for performing connection service to the Internet.

The above PC 303 is installed in order to restrict the access to data on Internet 306 by each data processing apparatus 100, and to collectively manage a print designated by each data processing apparatus 100. Besides, while the user does not use the data processing apparatus, advertisement and shop propaganda are displayed on the display screen so that the data processing apparatus 100 can be used as an advertising medium.

The above restriction of access means to inhibit from purchasing data delivered for payment or from making an access to page accessible for payment. The above print management means to charge the user for a fee in accordance to the number of printed sheets.

The network system as shown in FIG. 3 is built up, and thereby, the data processing apparatus 100 is usable as a terminal connected with the Internet 306. Therefore, it is possible to realize an environment capable of using the Internet 306.

In the present embodiment, in order to reduce a manufacture cost and improve an operating ratio, the data processing apparatus 100 is not mounted with a printing function and a recording apparatus. However, in this case, the data processing apparatus 100 may be mounted with the printing function and a recording apparatus, or other functions. The other functions include a function of counting the number of printed sheets, a function enabling the use by time corresponding to an amount of received money. As seen from the above description, the function and apparatus mounted to the data processing apparatus 100 are not limited to this embodiment, and various changes can be made.

The data processing apparatus 100 has an external appearance like table, but it is possible to reduce the thickness of the main body 101 depending on the employed display device 104. That is, the main body 101 can be formed as one flat plate. Therefore, the data processing apparatus 100 may be used as a table for putting something thereon.

Further, in the present embodiment, in the case where the data processing apparatus 100 is used as a table, a premise is made such that the number of persons sat on the first and second sides is by two. Thus, only one of two display screens 104a and 104b is used for actual display, and the image is displayed thereon. The above-mentioned construction is employed in common to each data processing apparatus 100; however, the construction may not be always employed. For example, in the case where three or more persons sit on the one side, that is, in the case where the data processing apparatus 100 is made long in the longitudinal direction, plural users may simultaneously use the data processing apparatus 100 at least one side. In order to realize the above data processing apparatus 100, one table may be mounted with a plurality of data processing apparatuses 100. In this case, various changes may be made according to a shape of the external appearance.

The place where the data processing apparatus 100 is installed is not limited to shops such as a restaurant, a tearoom and the like. In addition, the data processing apparatus 100 may be installed on the place where a person stays therein for a certain time, such as a waiting room of airplane and bus.

As is evident from the above description, according to the present invention, the data processing apparatus is used as a terminal for making a connection with a communication network, and is mounted to a table. Further, the data (image) is displayed on the display device provided at the surface of the table used for putting something.

In the case where the data processing apparatus has the above construction, the data processing apparatus is usable as a table, in addition to the terminal. Therefore, the data processing apparatus is installed, and thereby, it is possible to prevent a reduction of a space usable by the customer. As a result, it is possible to prevent a reduction of the number of persons accommodated in shop, and to realize an environment capable of using a communication network such as Internet and the like.

What is claimed is:

1. A data processing apparatus, which is used as a terminal for making a connection with a communication network, comprising:
a display device manufactured and used on the premise that something is put thereon, and having a display screen facing a flat-plate transmitting portion capable of transmitting a light;
communication means for making a communication with the communication network;
input means for inputting a request by a user; and
control means for carrying out a control in a manner that a data corresponding to the request inputted by the input means is received by the communication means receives, and the received data is displayed on the display screen by the display device.

2. The data processing apparatus according to claim 1, wherein the display device further includes selection means for selecting a direction of displaying a data on the display screen by the user, and
the control means carries out in a manner that the display device displays the data on the display screen according to the direction selected by the selection means, that is, the user.

3. The data processing apparatus according to claim 2, wherein in the case where a plurality of the input means is provided, the control means selects a valid input means from the plurality of the input means according to the direction selected by the selection means, that is, the user.

4. A method for manufacturing a data processing apparatus, which is used as a terminal for making a connection with a communication network, comprising the following steps of:
providing a transmitting portion capable of transmitting a light at a surface used for putting something on a table;
providing a display device having a display screen facing the transmitting portion provided at the surface; and
mounting communication means for making a communication with the communication network, input means for inputting a request by a user, and control means for carrying out a control in a manner that a data corresponding to the request inputted by the input means is received by the communication means receives, and the received data is displayed on the display screen by the display device, which constitute the data processing apparatus, on the table.
